(19) United States
(12) Patent Application Publication
(10) Pub. No.: US 2002/0082947 A1
(43) Pub. Date: Jun. 27, 2002

(54) Medical exercise testing investment planning method and apparatus

(76) Inventor: David P. Schlageter, Mequon, WI (US)

Correspondence Address: Patrick S. Yoder, Suite 330, 7915 Fm 1960 West, Houston, TX, 77070, US

(21) Appl. No.: 09/746,827

(22) Filed: Dec. 22, 2000

(51) Int. Cl. G06F 17/60

(52) U.S. Cl. 705/27

(57) ABSTRACT

A system and method for providing an exercise testing system customer with a recommended exercise testing system. The recommended exercise testing system being established by a customer's responses to a plurality of questions provided to the customer over a network via a query page. The system having a product selector file and a product configuration file. The product selector file provides the query page with the plurality of questions to be answered by the customer. The product configuration file having a plurality of exercise testing systems associated with specific responses to the questions on the query page. A Java applet being used to compare the customer's responses to the plurality of questions to the information in the product configuration file. The product configuration file supplying a results page with the recommended system based on the customer's responses to the questions on the query page. The system providing the results page to the customer over the network.

### FIELD OF THE INVENTION

The present invention relates generally to a method and apparatus for providing purchasing information to an exercise testing system, and more particularly, to a method and apparatus to enable an exercise testing system supplier to provide a customer with a recommended an exercise testing system.

### BACKGROUND OF THE INVENTION

A stress test, sometimes referred to as a treadmill test or an exercise test, assists physicians determine how well the heart deals responds to work. As the body works harder during the stress test, the heart has to pump more blood. Concurrently, the heart requires more oxygen to function. The stress test can show if the blood supply is reduced in the arteries that supply the heart. The stress test can also assist a physician in determining the overall functional capacity of a patient and the appropriate kind and levels of exercise for the patient.

A person undergoing a stress test is hooked up to equipment that monitors the heart. The person then begins walking slowly on a treadmill. The speed of the treadmill may be increased or the treadmill may be given an upward tilt to simulate walking uphill. The patient may also be asked to breathe into a tube for a couple of minutes. The patient's heart rate is monitored and blood pressure is checked during and after the test.

Heart rate, breathing, and blood pressure may be measured and an electrocardiogram (ECG) may be performed during the test. An ECG is a well-established method for studying the function of the heart and identifying disorders of the heart. ECG analysis provides graphical information that can indicate abnormalities in the heart such as irregular heart rates or rhythms, or abnormal conduction pathways. Likewise, an ECG can indicate the location of damaged cardiac tissues if it exists. Perhaps best of all, the ECG allows a physician to diagnose abnormalities inexpensively, without using surgical procedures

An ECG is a graphic tracing of the variations and the electrical potential caused by the excitation of the heart muscle as detected at the body surface by leads of the ECG device. A normal electrocardiogram is a scale or representation that shows deflections resulting from cardiac activity as changes in the magnitude of voltage and polarity over time and includes a P-Wave, a QRS complex, and a T-Wave. The P-Wave is due to atrial contraction and is known as the atrial complex. The Q, R S, deflections are all due to the action of the ventricles and are known as the ventricular complexes. The T-Wave occurs during ventricular re-polarization. These waves are then analyzed using a set of rules and parameters to determine what is normal and what is not. Certain deviations are used to flag possible complications.

To purchase an exercise testing system, a customer may contact a supplier of exercise testing systems to request information regarding the supplier's exercise testing systems. Alternatively, an exercise testing system supplier may contact a customer in hopes of generating sales of exercise testing systems. Both parties in each of these cases may waste significant amounts of time attempting to elicit basic information from the other. For example, it may take an exercise testing system supplier a significant amount of time to establish the customer's basic exercise testing system needs or desires. Additionally, a customer may expend significant amounts of time obtaining basic information about the exercise testing systems available from the supplier. Indeed, the customer may receive information about exercise testing systems that are simply not suited for the customer's needs.

There is a need, therefore, for an improved technique for providing an exercise testing system customer with purchasing information regarding a supplier's exercise testing systems prior to contact between a sales representative of the supplier and the customer. There is a particular need for a system or method that provides a customer with information for a recommended exercise testing system in response to a customer query designed to provide the supplier with some basic information about a customer's needs for an exercise testing system.

### SUMMARY OF THE INVENTION

According to one aspect of the present invention, a system is featured. The system is coupled to a network to enable an exercise testing system supplier provide a customer with a recommended exercise testing system. The system comprises an application server, a comparison program and a server. The application server directs a query page to the customer via the network. The query page has a plurality of questions and a plurality of answer choices for each question. A customer's answers to the questions enable the system to determine a recommended exercise testing system. At least one question is designed to determine a range of exercise tests the customer desires to perform with the exercise testing system over a defined time interval. The system also comprises a comparison program to receive a completed query page containing the customer's answers to the questions. The comparison program compares the customer's answers to information stored in the system that relates the customer's answers to specific exercise testing systems. The specific exercise testing that corresponds to a customer's answers being the recommended exercise testing system. The system also comprises a server to provide a results page to the customer via the network. The results page provides the customer with the recommended exercise testing system.

According to another aspect of the present invention, a computer system is featured. The computer system is coupled to a network to enable an exercise testing system supplier to provide a customer with a recommended exercise testing system over the network. The computer system comprises an application server, a product selector file, a program, and a product configuration file. The application server is coupled to a network. The application server directs a customer from the network to files stored in the computer system. The product selector file is written in a markup language and stored in the computer system. The product selector file holds a plurality of questions designed to obtain data from a customer to determine a rested ECG system, from among a plurality of exercise testing systems, to recommend to the customer. The product selector file provides the plurality of questions to a query page for delivery to a customer. The program operates to determine a recommended exercise testing system for the customer by comparing data provided by the customer via the plurality of questions to exercise testing system data stored in the computer system. The product configuration file is written in a markup language and stored in the computer system. The product configuration file holds the exercise testing system data used by the program. The product configuration file also provides the recommended exercise testing system to a results page for delivery to the customer.

According to another aspect of the present invention, a method is featured of utilizing a computer system coupled to a network to assist a customer to configure a resting electrocardiograph (ECG) system. The method enables a supplier to recommend an exercise testing system to the customer from among a plurality of exercise testing systems, components and software. The method comprising the act of routing a request for assistance from a customer to a product selector file written in extensible markup language (XML). The product selector file fills a template with questions stored in the product selector file. The method also comprises the acts of delivering the template over the network to a customer and receiving a completed template from the customer. The method also comprises the act of determining a recommended exercise testing system configuration by comparing customer data derived from the completed template to supplier data stored in the computer system in a product configuration file written in XML. The product configuration file fills a results page with the recommended exercise testing system configuration for delivery to the customer over the network.

### BRIEF DESCRIPTION OF THE DRAWINGS

FIG. 1 is a visual representation of a person undergoing an exercise testing examination;

FIG. 2 is a list of questions for use in a product selector for an exercise testing system;

FIG. 3 is a template of exercise testing systems corresponding to predicted answers to the question of FIG. 2;

FIG. 4 is a diagrammatical representation of a computer system to enable an exercise testing system supplier to provide a customer with a recommendation for an exercise testing system;

FIG. 5 is a flowchart for a process whereby an exercise testing system supplier may provide a customer with a recommendation for an exercise testing system;

FIG. 6 is a representation of a page for an exercise testing system supplier, the page having a link to an exercise testing system product selector;

FIG. 7 is a representation of a query page for an exercise testing system product selector;

FIG. 8 is a representation of a help page for an exercise testing system product selector;

FIG. 9 is a representation of a results page featuring a recommended exercise testing system; and

FIG. 10 is a representation of a results page when the system cannot provide a recommended exercise testing system and directing the customer to contact a supplier's representative.

### DETAILED DESCRIPTION OF THE INVENTION

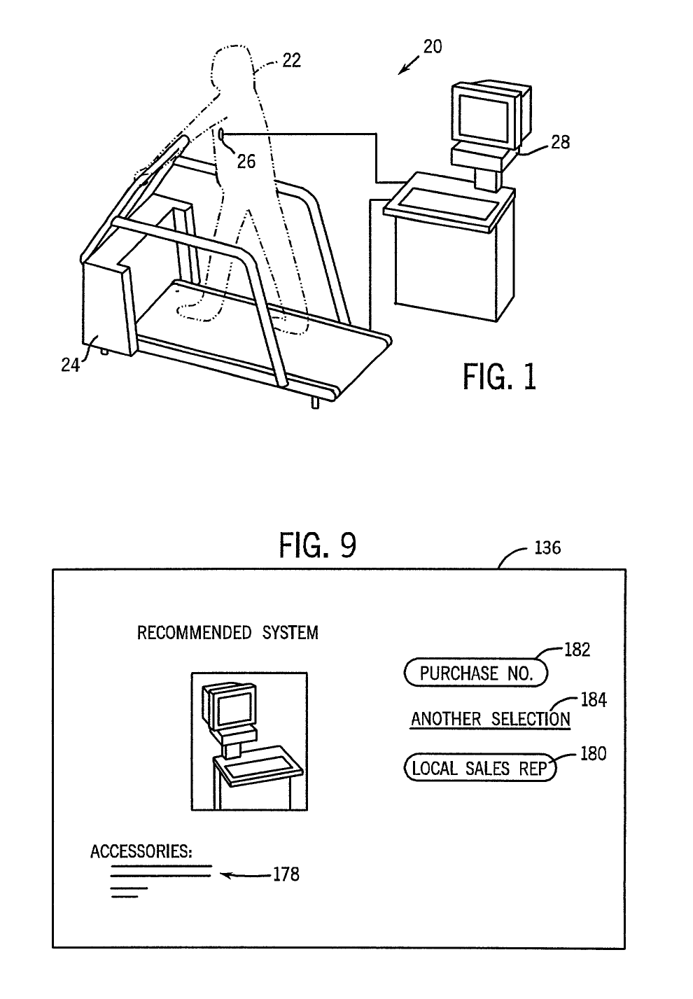

FIG. 1 illustrates an exercise testing system 20. To perform an exercise test, a patient 22 walks and/or runs on a treadmill 24. Electrodes 26 are placed on the patient's body to sense heart activity during the exercise test. An exercise-testing computer 28 is used to analyze heart activity data collected from the electrodes 26. The exercise testing computer 28 also may receive data from the treadmill 24, such as the length and rate of the exercise test. The exercise testing system may also receive data from other systems, such as an ergometer, an ultrasound, and a nuclear camera.

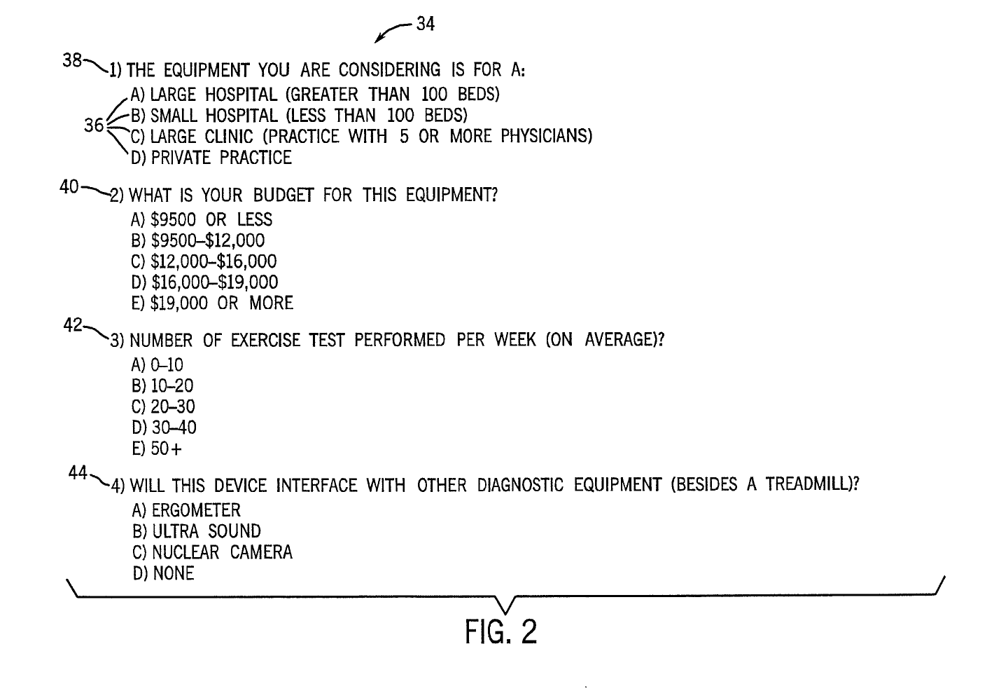

Referring generally to FIG. 2, an exemplary list 34 of questions that may be used to elicit information from an exercise testing system customer is provided. The questions may be used to recommend an exercise testing system that meets the customer's needs or at least provide a basis for discussion between the supplier and the customer. Each answer to each question is shown with an associated letter identifier 36. The questions and answers may vary from supplier to supplier depending on the exercise testing systems the supplier provides to customers.

In the list of question featured in FIG. 2, the first question 38 asks, “The equipment you are considering is for a:” which is followed by four answer choices: “A. Large hospital”, “B. Small hospital”, “C. Large Clinic”, and “D. Private practice.” The answer may be used to gage the customer's requirements for an exercise testing system so that the supplier may recommend the most appropriate The answer may be used to gage the customer's requirement for an exercise testing system so that the supplier may recommend the most appropriate exercise testing system for the customer. Additionally, the supplier may have separate sales groups for different clinical settings. In that situation, the customer's response to the first question 38 may be used during discussions between the customer and the supplier to determine the appropriate sales group to do business with the customer.

Primarily, the questions are designed to elicit information from the customer so that an exercise testing system may be recommended to the customer. For example, the second question 40 asks, “What is your budget for this equipment?” The answer options for the second question 40 are: “A. $9500 or less”, “B. $9500 to $12,000”, “C. $12,000 to $16,000”, “D. $16,000-$19,000”, and “E. $19,000 or more.” This information may be used to identify the best exercise testing system within the customer's budget for an exercise testing system. The third question 42 asks “What is the number of exercise tests performed per week (on average)?” The answer choices for the third question 42 are: “A. 0-10”, “B. 10-20”, “C. 20-30”, “D. 30-40”, and “E. 50+.” This indicates the degree of use that the exercise testing system would have. A customer that performs only a few exercise tests per week may not need the same system that a customer who performs over 50 tests a week might. The fourth question 44 asks, “Will this device interface with other diagnostic equipment (besides a treadmill)?” The answer choices for the fourth question 44 are “A. Ergometer”, “B. Ultrasound”, “C. Nuclear camera”, or “D. None.” An exercise testing system that cannot interface with the identified diagnostic equipment is probably not going to be recommended by a supplier.

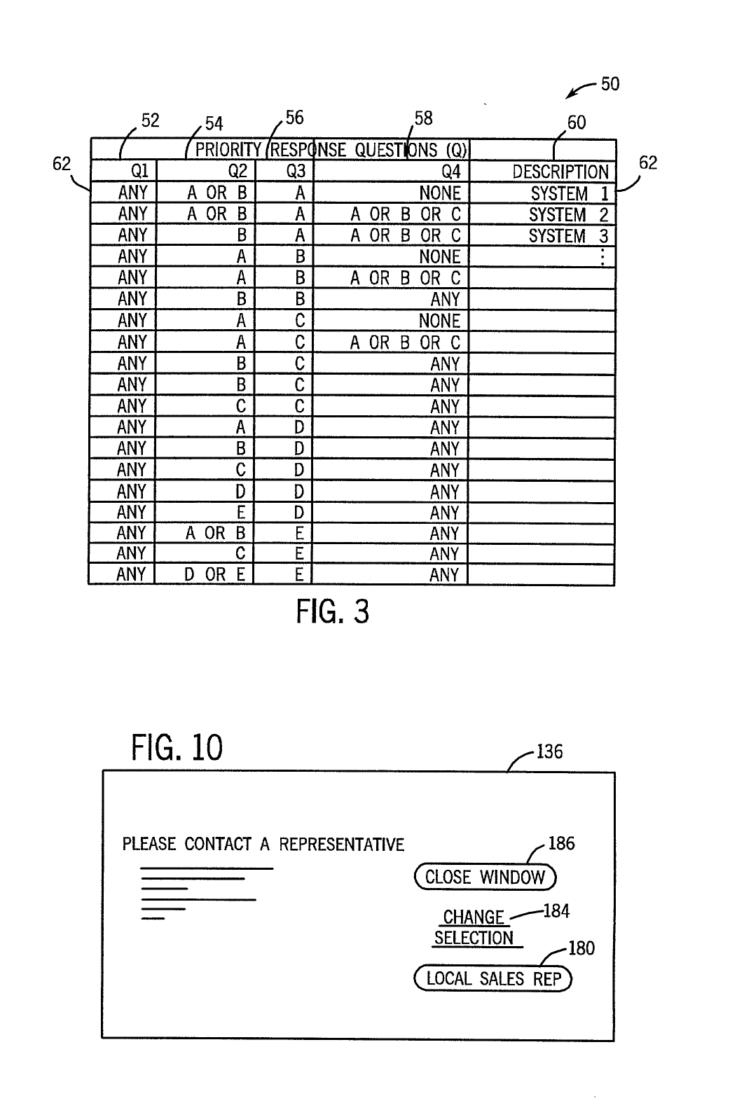

Referring generally to FIG. 3, an exemplary logic template 50 is provided. The logic template 50 correlates combinations of answers to the questions to exercise testing systems. An exercise testing system is recommended to the customer if the combination of answers provided by the customer corresponds to a combination of answers in the template 50 that have an exercise testing system associated with them.

In the illustrated embodiment, answers to each of the questions listed in FIG. 2 are shown in separate columns. Answers to the first question 38 are provided in a first column 52. Answers to the second question 40 are provided in a second column 54. Answers to the third question 42 are provided in a third column 56. Answers to the fourth question 44 are provided in a fourth column 58. Additionally, there is a column 60 for recommended exercise testing systems.

Each row comprises the combination of answers to the questions that correspond to an exercise testing system. For example, in the first row 62, the recommended exercise testing system is identified as “SYSTEM 1”, as referenced by arrow 64. SYSTEM 1 is recommended whenever the customer: selects any of the answers to the first question 38 (The equipment you are considering is for a:), selects “A. $9,500 or less” or “B. $9,500-$12,000” to the second question 40 (What is the anticipated study volume?), selects “A.0-10” to the third question 42, “Number of exercise tests per week?), and “None” to the fourth question 44 (Will this device interface with other diagnostic equipment (besides a treadmill)?). The rows that follow the first row 62 correspond to other combinations of answers that correspond to recommended exercise testing systems.

Not every exercise testing system supplied by a supplier may be one of the available recommended exercise testing systems. The exercise testing systems selected as recommended exercise testing systems may be selected for a number of reasons, such as their popularity with customers based on previous sales, ease of configuration with options, etc. The supplier may not recommend a specific exercise testing system if the combination of answers provided by the customer does not match any of the answers associated with a recommended exercise testing system. Rather, the supplier may inform the customer to contact a sales representative to identify the best exercise testing system for the customer's exercise testing system needs.

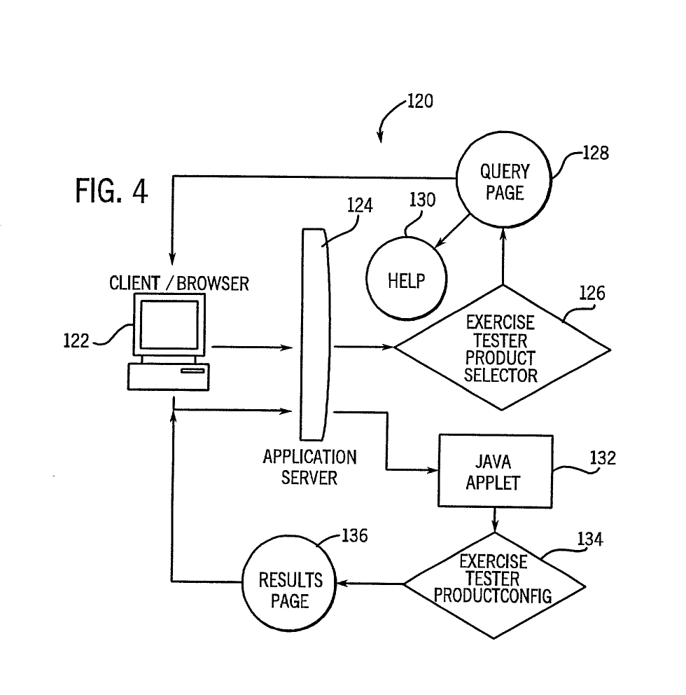

Referring generally to FIG. 4, a system 120 is illustrated that enables an exercise testing system supplier to provide a customer with a recommended exercise testing system. In the illustrated embodiment, a customer may use a computer 122, or other browsing device to access the system 120 over a network, such as the Internet. The system 120 utilizes an application server 124, an Exercise Testing product selector file 126, a query page 128, a help page 130, a Java applet 132, an Exercise Testing product configuration file 134 and a results page 136 to provide a customer with a recommended exercise testing system. The application server 124 is used to route information around system 120. The application server may comprise a program, such as a Java class. The Exercise testing product selector file 126 holds the data that is used to populate the query page 128 to be supplied to the customer. The query page 128 contains the question designed to enable an exercise testing system supplier to recommend an exercise testing system to meet the customer's needs, or at least provide a basis for discussion between the supplier and the customer. The help page 130 is linked to the query page 128 and contains additional information designed to assist a customer in answering at least one of the questions.

The Java applet 132 forms part of the logic functions illustrated in FIG. 3. The Java applet 132 compares the answers in the completed query page 128 to data in the Exercise Testing product configuration file 134. The Exercise Testing product configuration file contains a set of data for a plurality of exercise testing systems that correspond to predicted responses to the questions in the Exercise Testing product selector file. All possible combinations of answers to the plurality of questions may be provided with an associated, or recommended, exercise testing system. Alternatively, some, but not all, of the possible combinations may be provided with a recommended, exercise testing system. This smaller set of combinations may be based on a number of factors. For example, the Exercise Testing product configuration file 134 may be written so that a recommendation is made only for the most commonly sold configurations of exercise testing systems. If the Java applet 132 finds a match between the customer's response and a predicted response, the exercise testing system information corresponding to the predicted response is provided to the customer via the results page 136. If there is no match, an advisory to contact a sales representative may be provided to the customer.

In the illustrated embodiment, the Exercise Testing product selector file 126 and the Exercise Testing product configuration file 134 are XML files. XML is a method for putting structured data in a text file. XML is powerful because it maintains the separation of the user interface from structured data. HTML specifies how to display data in a browser, but XML defines the content. For example, in HTML tags are used to tell the browser to display data as bold or italic. In XML, style sheets are employed to present the data in a browser. XML separates the data from the presentation and processing, enabling data to be displayed and processed differently by applying different style sheets and applications.

As will be appreciated by those skilled in the art, XML is a meta-markup language that provides a format for describing structured data. This facilitates more precise declarations of content and more meaningful search results across multiple platforms. An unlimited set of tags may be defined in XML. As noted above, while HTML tags may be used to display a word in bold or italic, for example, XML provides a framework for tagging structured data. An XML element can declare its associated data to be a price, a tax, a title, or any other desired data. As XML tags are adopted, there will be a corresponding ability to search for and manipulate data regardless of the applications within which it is found. Once data has been located, it can be delivered over a network and presented in a browser in any number of ways, or it can be handed off to other applications for further processing and viewing.

XML is a subset of the Standard Generalized Markup Language (SGML) that is optimized for delivery over the Web. XML provides a data standard that can encode the content, semantics, and schemata for a wide variety of cases ranging from simple to complex, and which may be used to markup the following: an ordinary document; a structured record, such as an appointment book or purchase order; an object with data and methods, such as the persistent form of a Java object; a data record, such as the result set of a query, meta content of a site; graphical presentations; standard schema entities and types; and all links between entities and types. Once the data is on the client's desktop it can be manipulated, edited, and presented in multiple views, without returning to the server. Servers may then become more scalable, due to lower computational and bandwidth loads. Also, because data is exchanged in the XML format, it can be easily merged from different sources. In the illustrated embodiment, the Exercise testing product selector file is an XML file. However, Exercise testing product selector file 126 may be defined by other file or application types, including a different markup language, such as HTML.

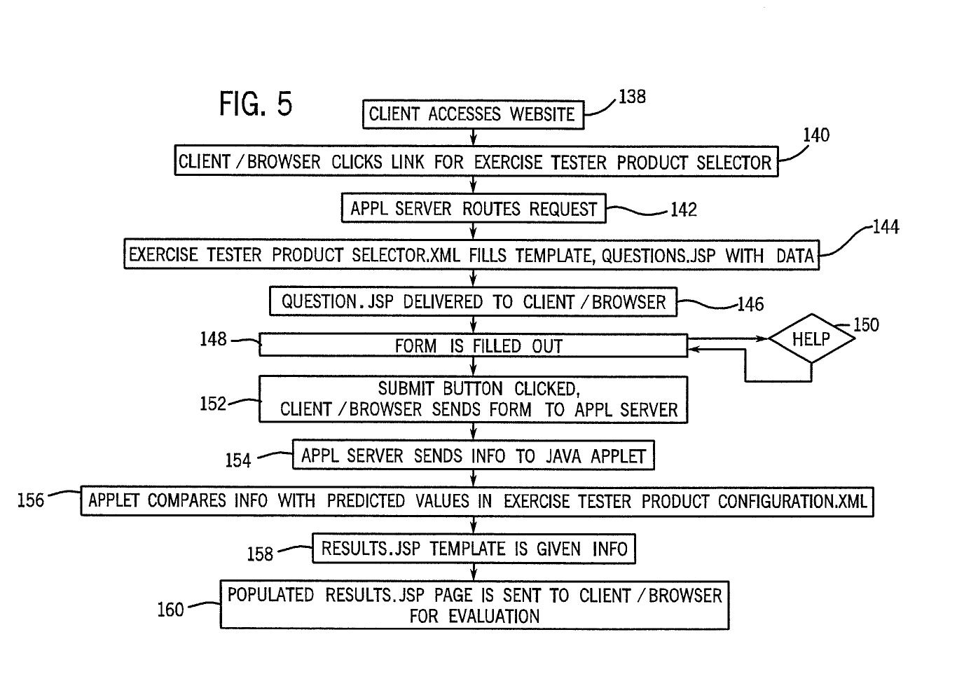

Referring generally to FIG. 5, an exemplary process by which a customer may be provided with information for a recommended exercise testing system is illustrated. Initially, a customer or client accesses a site, as referenced by step 138. The site may provide an exercise testing system supplier home page, an exercise testing system specification page, a product selector page, or some other page of interest to a customer or client interested in purchasing a supplier's exercise testing systems, exercise testing system components, software, etc. Initially, the client or customer activates a link on the page to enter an exercise testing system product selector, as referenced by step 140. An application server routes the request to enter the exercise testing system product selector to a Exercise Testing System product selector file, as referenced by step 142. In an exemplary embodiment, the Exercise Testing product selector file is an XML file. The Exercise Testing System product selector file contains the data representing the questions to ask a customer to narrow the choice of an exercise testing system, component, or software to a recommended exercise testing system, component, or software. The Exercise Testing System product selector file fills the query page template with the data, e.g., questions, as referenced by step 144. In an exemplary embodiment, the query page is a Java script file. The query page is sent to the customer browser for completion, as referenced by step 146.

The customer then completes the query page, as referenced by step 148. If a customer would like additional information to help in choosing an answer, the client may activate a link to a help file, as referenced by step 150. When the link is activated, a help page 130 is presented to the customer. In this embodiment, the help page 130 provides additional information specific to each question on the query page. The additional information is designed to assist the customer answer the questions. After obtaining the information, the customer may then return to the query page and continue answering questions. When the customer has completed answering the questions, the completed query page is sent back to the application server by activating a virtual button on the query page, as referenced by step 152.

In the exemplary process, the application server couples the completed query page 128 to a Java applet 132, as referenced by step 154. The Java applet 132 compares the information provided by the customer in their answers to the questions in the query page to predicted responses to the questions contained within the Exercise Testing product configuration file 134, as referenced by step 156. If a match is found between the customer's response to the questions and the predicted responses to the questions, the results page 136 is filled with data describing the recommended exercise testing system, component, or software, that corresponds to the predicted responses to the questions, as referenced by step 158. The results page 136 is then provided to the customer for viewing and/or evaluation, as referenced by step 160.

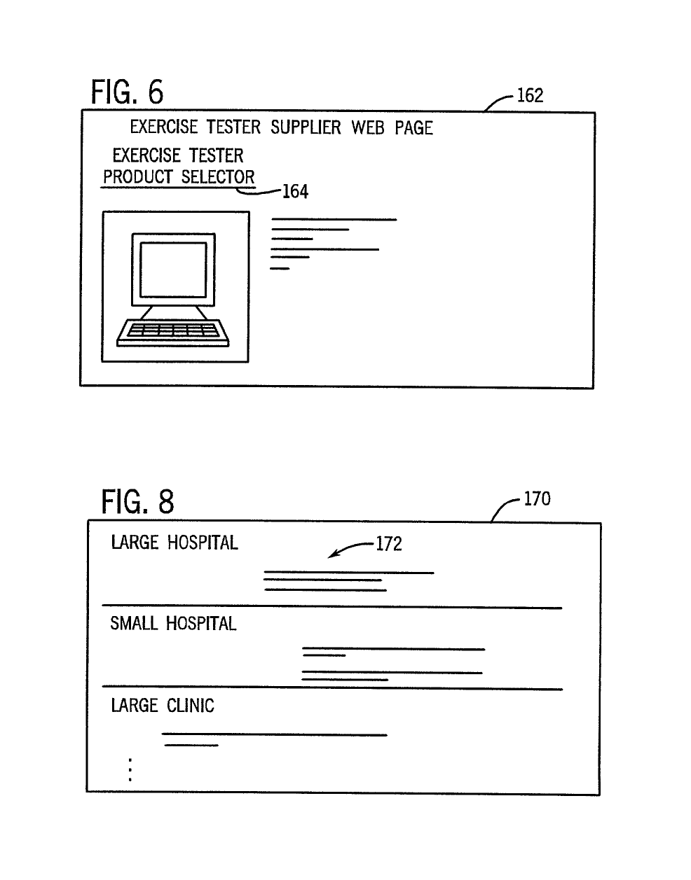

Referring generally to FIG. 6, a page 162 for an exercise testing system supplier is illustrated. The page 162 may contain information about the suppliers exercise testing systems, components or software. In addition, the page 162 also contains a link 164 to an exercise testing product selector.

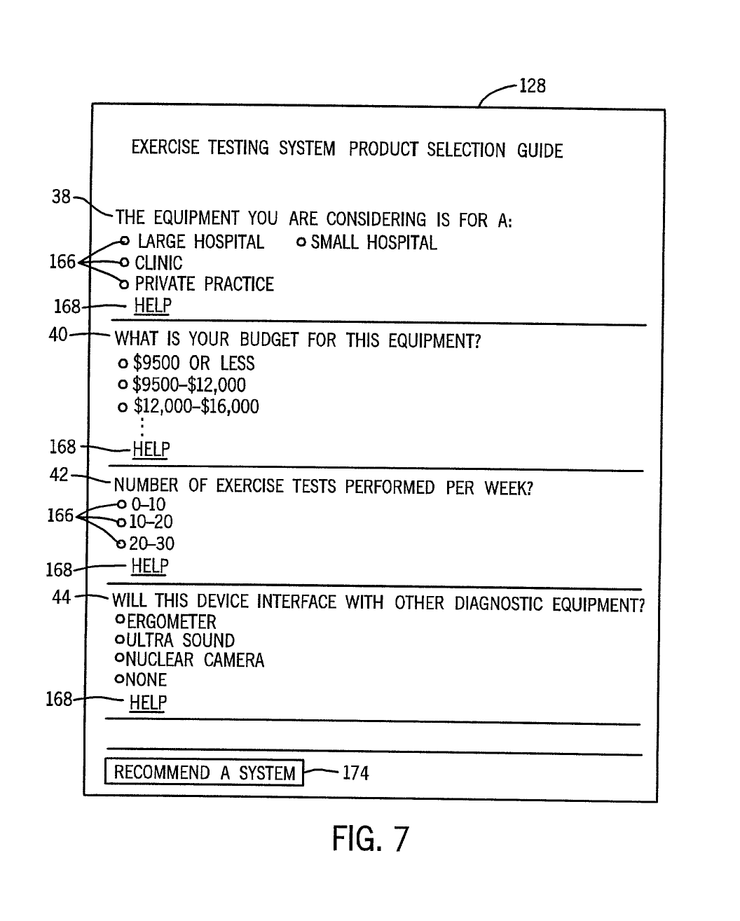

Referring generally to FIG. 7, when the link 164 is activated, system 120 operates to provide the customer browser 122 with a query page 128. In the illustrated embodiment, the page contains the series of questions from FIG. 2. Each question is answered by selecting one or more of the choice registers 166. Some questions may have mutually exclusive answers while others may allow multiple answers. An answer may be selected by placing a cursor over a choice register 166 and clicking with a mouse virtual button.

In addition, each question may have a link 168 to the help file 130. When the link is activated a small browser window 170 is opened, as best illustrated in FIG. 8. In the illustrated embodiment, the link 168 after the question, “The equipment you are considering is for a:” has been activated. Browser window 170 contains text 172 describing a large hospital, a small hospital, a large clinic, and a private practice. However, browser window 170 and help file 130 may be populated with any type of information that may be designed to assist a customer in answering any of the questions provided to the customer. Referring again to FIG. 7, when the customer has made their selections, a virtual button 174 is activated. Activating the virtual button 174 directs the query page to be returned to the system 120 and directs the system 120 to provide the customer with a recommended exercise testing system, component or software.

Referring generally to FIG. 9, system 120 provides the recommendation for an exercise testing system, component, and/or software on a results page 136. The results page 136 provides the customer with a recommended system 176 and recommended options 178. Additionally, results page 136 may have a virtual button 180 that is operable to activate a program to identify a supplier sales representative located near the customer. The results page 136 may also have a purchasing link 182 to initiate a purchasing program to enable a customer purchase an exercise testing system, component, and/or software. The results page 136 may also have a link 184 to enable a customer perform another product selection with the exercise testing product selector.

As best illustrated in FIG. 10, if there is no exercise testing system, component, or software that matches the customer's responses to the questions the results page 136 may inform the customer that no exercise testing system, component, or software may be recommended based on the customer's responses to the questions. The customer may be informed to contact an exercise testing system supplier's sales representative. Therefore, this embodiment of results page 136 also may have a virtual button 180 that is operable to activate a program to identify the supplier's sales representative nearest to the customer. The results page 136 also may have a virtual button 186 to close the browser to close the product selector.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A computer system coupled to a network to enable an exercise testing system supplier to provide a customer with information relating to a recommended exercise testing system, the computer system comprising:
an application server to direct a query page to the customer via the network, wherein the query page comprises a plurality of questions and answers designed to enable the computer system to determine a recommended exercise testing system based on the customer's answers to the plurality of questions, further wherein at least one of the plurality of questions and answers establishes a range of exercise tests to be performed by the exercise testing system over a defined time interval;
a comparison program to receive the customer's answer choices and compare the customer's answer choices to a plurality of predicted answer choices, each of the plurality of predicted answer choices corresponding to a specific exercise testing system; and
a server to provide a results page to the customer via the network, the results page providing the customer with the specific exercise testing system as a recommended exercise testing system if the customer's answer choices match the predicted answer choices corresponding to the specific exercise testing system.

2. The system as recited in claim 1, wherein at least one of the plurality of questions is designed to determine the budget for the exercise testing system.

3. The system as recited in claim 1, wherein at least one of the plurality of questions is designed to determine the customer's clinical environment.

4. The system as recited in claim 1, wherein at least one of the questions is designed to determine if the exercise testing system is to be interfaced with other diagnostic equipment.

5. The system as recited in claim 4, wherein the diagnostic equipment is a treadmill.

6. The system as recited in claim 4, wherein the diagnostic equipment is a nuclear camera.

7. The system as recited in claim 4, wherein the diagnostic equipment is an ergometer.

8. The system as recited in claim 4, wherein the diagnostic equipment is an ultra sound.

9. The system as recited in claim 1, wherein at least one of the plurality of questions is designed to identify to the supplier the specific sales entity within the supplier in which to direct the customer to conduct business with the supplier.

10. The system as recited in claim 1, wherein the application server comprises a Java class.

11. The system as recited in claim 1, wherein the comparison program comprises a Java applet.

12. The system as recited in claim 1, wherein the plurality of predicted answer choices and the corresponding specific exercise testing systems are stored in a product selector file.

13. The system as recited in claim 12, wherein the product selector file is written in extensible markup language (XML).

14. The system as recited in claim 1, wherein the query page is written in Java script.

15. The system as recited in claim 1, wherein the query page comprises a link to a help page, wherein the help page provides information to assist a customer answer at least one of the plurality of questions.

16. The system as recited in claim 1, wherein each question has an associated link to a help page, wherein the help page provides information to assist a customer answer each of the plurality of questions.

17. The system as recited in claim 1, wherein specification information for each of the specific exercise testing systems is stored in a product configuration file.

18. The system as recited in claim 17, wherein the product selector file is written in extensible markup language (XML).

19. The system as recited in claim 1, wherein the exercise testing system comprises an electrocardiograph.

20. The system as recited in claim 18, wherein the product selector file populates the results page with a specific exercise testing system configuration that matches the customer's responses in the completed query page.

21. The system as recited in claim 1, wherein the results page is written in Java script.

22. A computer system coupled to a network to enable an exercise testing system supplier provide a customer with a recommended exercise testing system via the network, the computer system comprising:
an application server coupled to a network, the application server directing a customer to files stored in the computer system;
a product selector file written in a markup language and stored in the computer system, the product selector file defining a plurality of questions designed to elicit data from a customer to determine a exercise testing system to recommend to the customer from among a plurality of exercise testing systems, wherein the product selector file provides the plurality of questions to a query page for delivery to a customer;
a program that operates to determine an exercise testing system to recommend to the customer by comparing data provided by the customer via the plurality of questions to exercise testing system data stored in the computer system; and
a product configuration file written in a markup language and stored in the computer system, the product configuration file holding the exercise testing system data used by the program, wherein the product configuration file provides information relating to a recommended exercise testing system to a results page for delivery to the customer.

23. The system as recited in claim 22, wherein at least one of the plurality of questions is designed to determine whether the customer's clinical purpose for using the exercise testing system.

24. The system as recited in claim 22, wherein at least one of the plurality of questions is designed to determine the customer's expected volume of use of the exercise testing system.

25. The system as recited in claim 22, wherein at least one of the plurality of questions is designed to determine the customer's expected method of data collection.

26. The system as recited in claim 22, wherein at least one of the questions is designed to determine the customer's expected means of exercise testing system data storage.

27. The system as recited in claim 22, wherein at least one of the plurality of questions is designed to identify to a representative of the supplier's a specific sales entity of the supplier's to which sales inquiries are to be directed.

28. The system as recited in claim 22, wherein the product selector file is written in extensible markup language (XML).

29. The system as recited in claim 22, wherein the product configuration file is written in extensible markup language (XML).

30. The system as recited in claim 22, wherein each question is a multiple-choice question.

31. The system as recited in claim 22, further comprising a help file written in a markup language and containing information regarding each choice in at least one multiple-choice question.

32. The system as recited in claim 31, wherein the help file is written in hypertext markup language (HTML).

33. The system as recited in claim 22, wherein the application server is a Java class.

34. The system as recited in claim 22, wherein the program is a Java applet.

35. The system as recited in claim 22, wherein the query page is written in a Java script language.

36. The system as recited in claim 22, wherein the results page is written in a Java script language.

37. The system as recited in claim 22, wherein a recommended computer system comprises software.

38. A method of utilizing a computer system coupled to a network to assist a customer to configure an exercise testing system from among a plurality of exercise testing systems, components and software, the method comprising the acts of:
routing a request for assistance from a customer to a product selector file written in extensible markup language (XML), wherein the product selector file fills a template with questions stored in the product selector file;
delivering the template over the network to a customer;
receiving a completed template from the customer; and
determining a recommended exercise testing system configuration by comparing customer data derived from the completed template to supplier data stored in the computer system in a product configuration file written in XML, wherein the product configuration file fills a results page with the recommended exercise testing system configuration for delivery to the customer over the network.

39. The method as recited in claim 38, wherein routing comprises activating a link in a page to an application server.

40. The method as recited in claim 39, wherein the application server routes the request to the product selector file.

41. The method as recited in claim 38, wherein the template is a Java script file.

42. The method as recited in claim 38, wherein the results page is a Java script file.

43. A method of utilizing a computer system to configure a recommended exercise testing system from among a plurality of exercise testing systems, components and software, the method comprising the acts of:
connecting a customer communication system to a computer system provided by a exercise testing system supplier;
routing a request for assistance from the customer to a product selector file written in extensible markup language (XML), wherein the product selector file fills a template with questions stored in the product selector file;
delivering the template to a customer;
completing the template with the customer communication system and transmitting it to the computer system;
receiving a completed template from the customer; and
determining a recommended exercise testing system and configuration by comparing customer data derived from the completed template to supplier data stored in the computer system in a product configuration file written in XML, wherein the product configuration file fills a results page with the recommended exercise testing system configuration for delivery to the customer communication system.

44. The method as recited in claim 43, wherein the customer communication system is a second computer system having an interface coupled to the Internet.

45. The method as recited in claim 43, wherein the supplier data comprises data for a plurality of exercise testing system configurations of components and software.

46. The method as recited in claim 43, wherein determining comprises using a program to compare the customer data to the plurality of exercise testing system configurations of components and software.

47. The method as recited in claim 43, wherein the product configuration file provides the results page with the data for a specific exercise testing system configuration of components and software when the program identifies a specific exercise testing system configuration that matches the customer data.
